(19) United States
(12) Patent Application Publication
(10) Pub. No.: US 2025/0158306 A1
(43) Pub. Date: May 15, 2025

(54) ELECTRICAL CONNECTOR AND METHOD OF MANUFACTURING ELECTRICAL CONNECTOR

(71) Applicant: SUMITOMO ELECTRIC INDUSTRIES, LTD, Osaka-shi (JP)

(72) Inventors: Yasunori ASANO, Osaka-shi (JP); Takeshi INOUE, Osaka-shi (JP)

(73) Assignee: SUMITOMO ELECTRIC INDUSTRIES, LTD., Osaka-shi (JP)

(21) Appl. No.: 18/905,251

(22) Filed: Oct. 3, 2024

(30) Foreign Application Priority Data
Nov. 13, 2023 (JP) 2023-192845

(51) Int. Cl. H01R 12/79; H01R 13/24; H01R 43/20

(52) U.S. Cl. CPC H01R 12/79; H01R 13/2407; H01R 43/20

(57) ABSTRACT

An electrical connector includes a plurality of conductors each extending along a first direction and arranged side by side in a second direction intersecting the first direction; a plurality of terminals each extending along a third direction intersecting the first direction and the second direction and arranged side by side in the second direction, each of the plurality of terminals being configured to be electrically connected to a corresponding conductor among the plurality of conductors; a carrier portion adjacent to proximal end portions of the plurality of terminals and extending in the second direction; and a housing accommodating distal end portions of the plurality of conductors, the plurality of terminals, and the carrier portion. Among the plurality of terminals, a ground terminal used as a ground line is connected to the carrier portion, and a signal terminal used as a signal line is not connected to the carrier portion.

### CROSS REFERENCE TO RELATED APPLICATIONS

This application claims priority based on Japanese Patent Application No. 2023-192845, filed on Nov. 13, 2023, and the entire contents of the Japanese patent application are incorporated herein by reference.

### TECHNICAL FIELD

The present disclosure relates to an electrical connector and a method of manufacturing an electrical connector.

### BACKGROUND

JP2016-129124A discloses an electrical connector mounted on a substrate. A plurality of conductive contacts are arranged in a multipolar manner inside a housing of the electrical connector.

### SUMMARY

An electrical connector according to an embodiment of the present disclosure includes a plurality of conductors each extending along a first direction and arranged side by side in a second direction intersecting the first direction; a plurality of terminals each extending along a third direction intersecting the first direction and the second direction and arranged side by side in the second direction, each of the plurality of terminals being configured to be electrically connected to a corresponding conductor among the plurality of conductors; a carrier portion adjacent to proximal end portions of the plurality of terminals and extending in the second direction; and a housing accommodating distal end portions of the plurality of conductors, the plurality of terminals, and the carrier portion. A ground terminal used as a ground line among the plurality of terminals is connected to the carrier portion, and a signal terminal used as a signal line among the plurality of terminals is not connected to the carrier portion.

### BRIEF DESCRIPTION OF THE DRAWINGS

FIG. 1 is a perspective view of an electrical connector according to an embodiment.

FIG. 2 is a cross section perspective view of the electrical connector shown in FIG. 1.

FIG. 3 is a cross-sectional view of the electrical connector shown in FIG. 1.

FIG. 4 is an enlarged view of a portion of the cross-sectional view shown in FIG. 3.

FIG. 5 is a perspective view of a plurality of terminals and a carrier portion of the electrical connector shown in FIG. 1.

FIG. 6 is a perspective view showing a terminal member.

FIG. 7 is a perspective view showing a locking structure in the electrical connector.

FIG. 8 is a perspective view showing a securing structure in the electrical connector.

### DETAILED DESCRIPTION

In the electrical connector described in JP2016-129124A, a plurality of conductive contacts are arranged in a multipolar manner in a width direction of the electrical connector. Thus, it is necessary to narrow the pitch between the conductive contacts. However, when the pitch between the conductive contacts is narrowed, crosstalk is worsened, so that the communication performance is worsened. Thus, an electrical connector capable of improving communication performance is desired.

An object of the present disclosure is to provide an electrical connector and a method of manufacturing an electrical connector, which can improve communication performance.

### Description of Embodiments of Present Disclosure

First, the contents of embodiments of the present disclosure will be listed and explained.

[1] An electrical connector according to an embodiment of the present disclosure includes a plurality of conductors each extending along a first direction and arranged side by side in a second direction intersecting the first direction; a plurality of terminals each extending along a third direction intersecting the first direction and the second direction and arranged side by side in the second direction, each of the plurality of terminals being configured to be electrically connected to a corresponding conductor among the plurality of conductors; a carrier portion adjacent to proximal end portions of the plurality of terminals and extending in the second direction; and a housing accommodating distal end portions of the plurality of conductors, the plurality of terminals, and the carrier portion. A ground terminal used as a ground line among the plurality of terminals is connected to the carrier portion, and a signal terminal used as a signal line among the plurality of terminals is not connected to the carrier portion.

The electrical connector includes the carrier portion adjacent to the proximal end portions of the plurality of terminals, and the ground terminal is connected to the carrier portion. In this case, since the ground terminal is integrated with the carrier portion to stabilize the ground, it is possible to reduce the influence of crosstalk and improve the communication performance of a signal propagating through the signal terminal or the like.

[2] In the electrical connector according to [1], each of the plurality of terminals may include a distal end portion configured to be elastically deformable. In this case, when the electrical connector is mounted on the substrate, the connection to the electrode pad on the substrate can be stabilized.

[3] The electrical connector according to [1] or [2] may further include a locking structure configured to secure the carrier portion to the housing. In this case, even when an external force is applied to the plurality of terminals, the external force can be received by the housing through the carrier portion connected to the plurality of terminals. Thus, it is possible to disperse the external force and stabilize the electrical connection of the plurality of terminals to the electrode pads and the like.

[4] In the electrical connector according to any one of [1] to [3], the housing may have an outer shell made of metal, and the carrier portion may be electrically connected to the outer shell and may be secured by the outer shell. The carrier portion is connected to the metallic outer shell, so that the ground is further stabilized and the communication performance can be further improved. In addition, since the carrier portion is secured to the outer shell, even when an external force is applied to the plurality of terminals, the external force is dispersed, and thus it is possible to stabilize electrical connection of the plurality of terminals to the electrode pads or the like.

[5] The electrical connector according to any one of [1] to [4] may further include a relay member configured to electrically connect each of the proximal end portions of the plurality of terminals to a corresponding distal end portion among the distal end portions of the plurality of conductors. In this case, the position of each of the proximal end portion of the plurality of terminals can be adjusted by changing the size and position of the relay member. Thus, it is possible to adjust the position of each of the distal end portions of the plurality of terminals. As a result, even when the plurality of terminals are arranged in a multipolar manner, each terminal can be stably and electrically connected to each corresponding electrode pad.

[6] A method of manufacturing an electrical connector according to an embodiment includes preparing a terminal member including a plurality of terminals and a first carrier portion connected to proximal end portions of the plurality of terminals; preparing a housing for the electrical connector, the housing being configured to accommodate the plurality of terminals; attaching the terminal member to the housing such that each of distal end portions of the plurality of terminals is located at a predetermined position with respect to the housing; and cutting a portion between a proximal end portion of a signal terminal used as a signal line among the plurality of terminals and the first carrier portion.

In this method of manufacturing an electrical connector, the portion between the proximal end portion of the signal terminal used as a signal line among the plurality of terminals and the first carrier portion is cut. In this case, since the ground terminal among the plurality of terminals is integrated with the carrier portion to stabilize the ground, it is possible to easily obtain an electrical connector in which the influence of crosstalk is reduced and the communication performance of a signal propagating through a signal terminal or the like is improved. The first carrier portion may be a carrier portion for feeding a product from a reel on a processing machine when a terminal is manufactured, or may be a member different from the carrier portion. When the first carrier portion is a carrier portion for feeding a product from a reel, the electrical connector can be easily manufactured and manufacturing costs can be reduced.

[7] In the method of manufacturing an electrical connector according to [6], the terminal member may include a second carrier portion connected to the distal end portions of the plurality of terminals. The method of manufacturing an electrical connector may further comprise separating the second carrier portion from the plurality of terminals. In this case, since the terminal member can be subjected to various manufacturing processes in a state in which both ends of the plurality of terminals are secured by the first carrier portion and the second carrier portion, the electrical connector can be easily manufactured even when there are a number of terminals. The second carrier portion may be a carrier portion for feeding a product from a reel on a processing machine when a terminal is manufactured, or may be a member different from the carrier portion. When the first carrier and the second carrier portion are both end carrier portions for feeding the product from the reel, the electrical connector can be manufactured more easily and manufacturing costs can be further reduced.

[8] The method of manufacturing an electrical connector according to [7] may further include bending the plurality of terminals in a state in which the plurality of terminals are kept connected to the first carrier portion and the second carrier portion. In this case, the bending can be easily performed on a large number of terminals, and the uniformity of the bending can be secured. Thus, an electrical connector having stable communication performance can be easily obtained.

### Details of Embodiments of Present Disclosure

Specific examples of the electrical connector according to embodiments of the present disclosure will be described below with reference to the drawings. In the following description, the same elements or elements having the same functions are denoted by the same reference numerals, and redundant description will be omitted. The present invention is not limited to these examples, but is defined by the scope of the claims, and is intended to include all modifications within the meaning and scope equivalent to the scope of the claims.

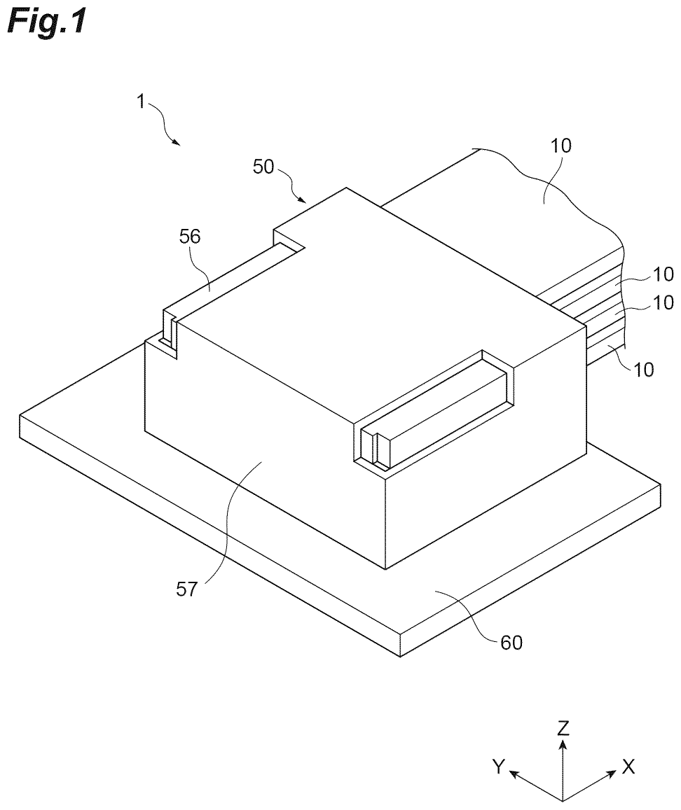

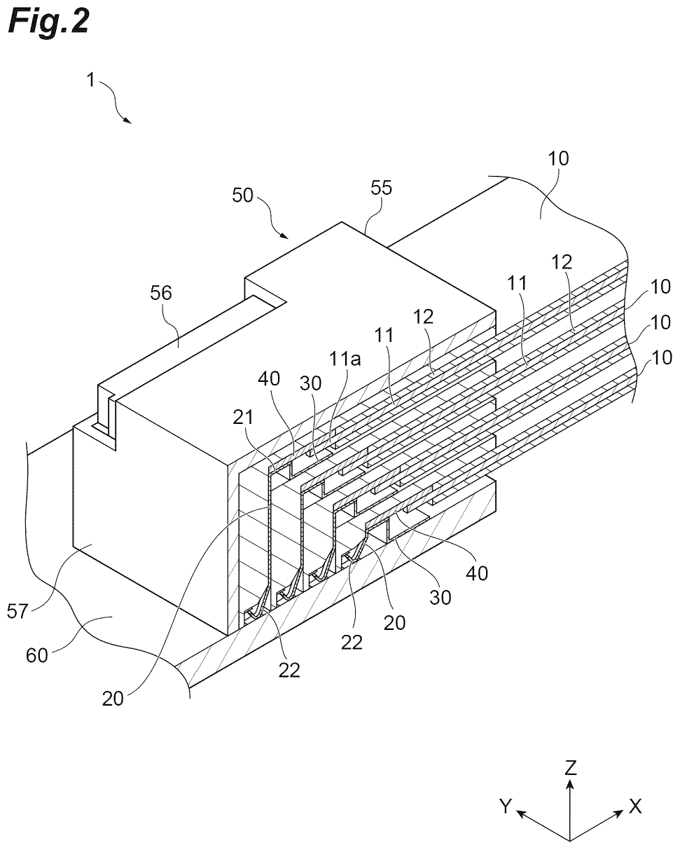

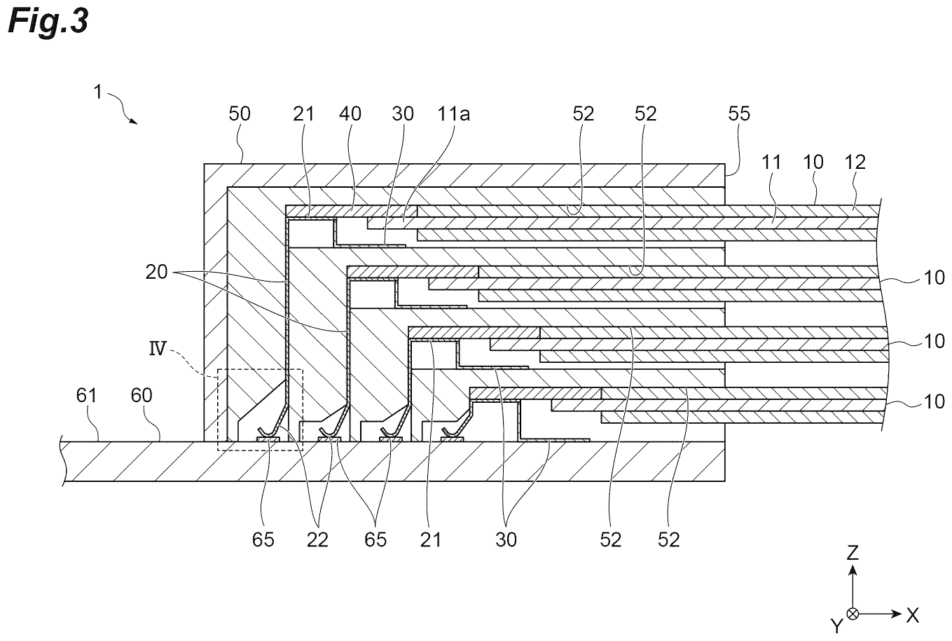

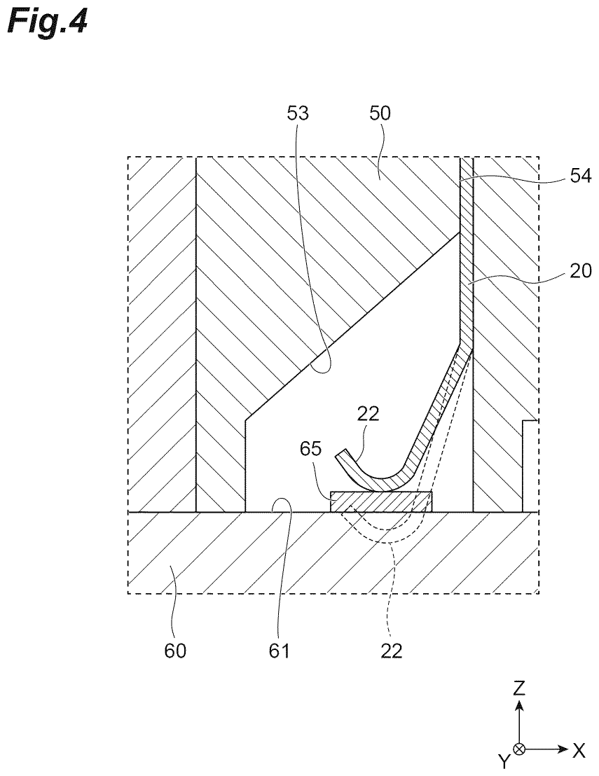

FIG. 1 is a perspective view of an electrical connector according to an embodiment. FIG. 2 is a cross section perspective view of the electrical connector shown in FIG. 1. FIG. 3 is a cross-sectional view of the electrical connector shown in FIG. 1. As shown in FIGS. 1 to 3, an electrical connector 1 includes an electrical cable 10, a plurality of terminals 20, a carrier portion 30, a relay member 40, and a housing 50. In the embodiment, for example, four electrical cables 10 are provided, but one or more electrical cables 10 can be provided. Each of electrical cables 10 is arranged in order in the Z direction. The plurality of terminals 20, carrier portion 30, and relay member 40 are provided corresponding to each of electrical cables 10. Electrical connector 1 is mounted on, for example, a substrate 60, and each of the plurality of terminals 20 is electrically connected to an electrode pad 65 (see FIG. 4) provided on substrate 60.

Electrical cable 10 includes a plurality of electric wires 11 and a coating portion 12 that covers the plurality of electric wires 11. Each of the plurality of electric wires 11 is formed of a metal such as copper, and is used as a signal line or a ground line. The plurality of electric wires 11 each extends along the X direction (first direction). The plurality of electric wires 11 provided in same electrical cable 10 are arranged side by side in the Y direction (second direction). For example, 2 to 200 electric wires 11 may be included in one electrical cable 10. Coating portion 12 is a member that covers a portion of electric wires 11 except for distal end portions 11a. The length of distal end portion 11a in the X direction is, for example, about 1 mm, but can be adjusted in consideration of the mounting strength of each component and the specifications of the transmission characteristics. The material of coating portion 12 is, for example, a resin such as polyester. Coating portion 12 integrates the plurality of electric wires 11 arranged in the Y direction, thereby forming electrical cable 10. Electrical cable 10 is, for example, a flexible flat cable (FFC).

Each of the plurality of terminals 20 is formed of a metal such as copper, and is used as a signal line or a ground line. The plurality of terminals 20 each extends along the Z direction (third direction). The plurality of terminals 20 corresponding to each electrical cable 10 (electric wires 11 incorporated therein) are arranged side by side in the Y direction. The plurality of terminals 20 corresponding to one electrical cable 10 may include, for example, 2 to 200 terminals 20.

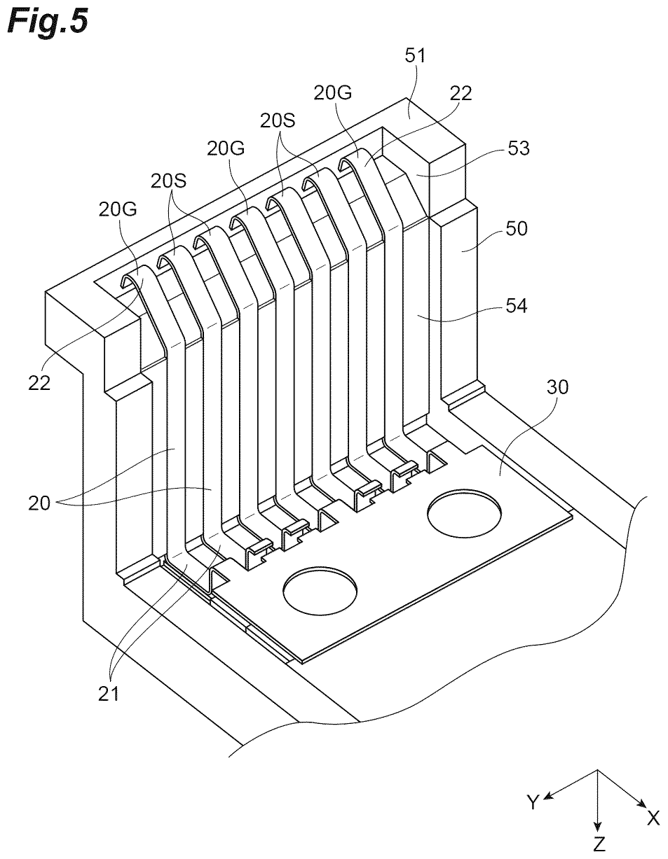

A proximal end portion 21 of each of the plurality of terminals 20 in the Z direction is held by relay member 40. For example, each proximal end portion 21 is soldered to relay member 40. Each of proximal end portions 21 is electrically connected to the corresponding electric wire 11 (distal end portion 11a) among the plurality of electric wires 11 in the pattern wiring of relay member 40. Although details will be described later, a ground terminal 20G used as a ground line among the plurality of terminals 20 is connected to carrier portion 30 (see FIG. 5). On the other hand, a signal terminal 20S used as a signal line among the plurality of terminals 20 is not connected to carrier portion 30. In other words, signal terminal 20S is isolated (cut) from carrier portion 30.

As shown in FIGS. 3 and 4, each of the plurality of terminals 20 has distal end portion 22 configured to be elastically deformable in the Z direction. Distal end portion 22 has, for example, J-shaped. Distal end portion 22 is configured to come into contact with the corresponding electrode pad 65 among the plurality of electrode pads 65 on substrate 60 in an elastically deformed state. Distal end portion 22 faces a main surface 61 of substrate 60 on a bottom surface 51 of housing 50. Distal end portion 22 protrudes from the bottom surface of housing 50 in a state before distal end portion 22 is in contact with electrode pad 65 (see a shape indicated by a dotted line in FIG. 4). For example, the length of distal end portion 22 protruding from bottom surface 51 may be 10 μm to 1000 μm, and is, for example, 200 μm.

Reference is again made to FIG. 3. Relay member 40 is a member for relaying electrical connection between the plurality of electric wires 11 and the plurality of terminals 20. In the embodiment, as an example, four electrical cables 10 are provided, and thus four relay members 40 are provided in electrical connector 1, but the present disclosure is not limited thereto. Relay member 40 has, for example, a plate shape, and is a paddle card as an example. Relay members 40 extend along the X direction and the Y direction. Relay members 40 are arranged along the Z direction. Each relay member 40 holds each proximal end portion 21 of the plurality of terminals 20 arranged in the Z direction. Distal end portions 11a of the plurality of electric wires 11 arranged in the Y direction and proximal end portions 21 of the plurality of terminals 20 arranged in the Y direction are electrically connected to the pattern wiring of relay member 40.

Housing 50 is a substantially rectangular parallelepiped member that holds distal end portions 11a of the plurality of electric wires 11, the plurality of terminals 20, carrier portion 30, and relay member 40. An outer shell 57 made of metal may be provided on the outside of a housing body 56 of housing 50. Housing body 56 of housing 50 is formed of a resin such as polyphenylene sulfide (PPS). Housing 50 further has a plurality of holding holes 52, a plurality of recesses 53 (see FIG. 4), and a plurality of hole portions 54 (see FIG. 4). The plurality of holding holes 52 each extends along the X direction and the Y direction. Holding holes 52 are arranged in the Z-direction. Each holding hole 52 is opened in a rear end surface 55 and extends from rear end surface 55 to the inside of housing 50. Each of the plurality of holding holes 52 holds electrical cable 10 and relay member 40. For example, relay member 40 is secured to the inner wall of holding hole 52 of housing 50 by press-fitting or with an adhesive or the like. Thus, housing 50 holds distal end portions 11a of electric wires 11, the plurality of terminals 20, and relay member 40.

A plurality of recesses 53 (see FIG. 4) is opened in bottom surface 51. The plurality of recesses 53 each extends along the Y direction. Recesses 53 are arranged in the X-direction. The plurality of hole portions 54 each extends along the Z direction. Each recess 53 communicates with a corresponding holding hole 52 among the plurality of holding holes 52 via a corresponding hole portion among the plurality of hole portions 54.

Each of the plurality of terminals 20 extends from the bottom of holding hole 52 to the inside of recess 53 via hole portion 54. Thus, by adjusting the position of relay member 40 in the X direction, the position of distal end portion 22 of each terminal 20 held by relay member 40 in the Z direction can be adjusted. Thus, the length of distal end portion 22 of each terminal 20 protruding from bottom surface 51 of housing 50 can be adjusted, and the amount of spring displacement of distal end portion 22 of each terminal 20 can be adjusted when electrical connector 1 is attached to substrate 60.

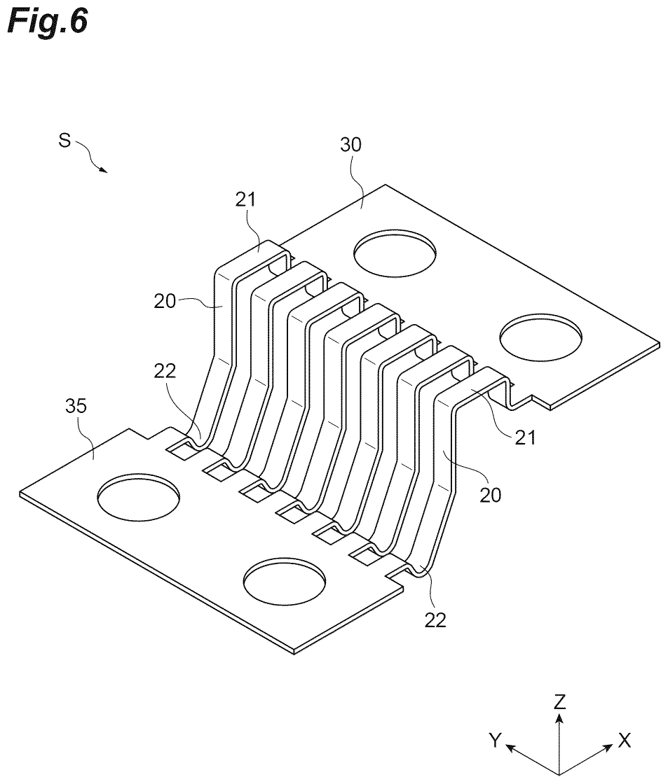

Referring now to FIG. 5, carrier portion 30 connected to a part of the plurality of terminals 20 will be described. FIG. 5 is a perspective view showing the plurality of terminals 20 and carrier portion 30 in electrical connector 1, and is a view of a part of electrical connector 1 as viewed from bottom surface 51. In FIG. 5, a set of the plurality of terminals 20 and carrier portion 30 is shown. The plurality of terminals 20 and carrier portions 30 of the other set have the same configuration except that terminals 20 have different lengths in the Z direction. As shown in FIG. 5, carrier portion 30 is a metal plate-like member extending in the Y direction, and is configured to be integrated with the plurality of terminals 20 (see FIG. 6 described later for details). However, carrier portion 30 and the plurality of terminals 20 do not have to be integrated. Carrier portion 30 is connected to ground terminal 20G used as a ground line among the plurality of terminals 20. On the other hand, carrier portion 30 is not connected to (cut from) signal terminal 20S used as a signal line among the plurality of terminals 20.

Next, a method of manufacturing electrical connector 1 using a terminal member S shown in FIG. 6 will be described. Terminal member S is a member including the plurality of terminals 20 and carrier portion 30. In this manufacturing method, first, electrical cable 10 is prepared. As shown in FIG. 6, terminal member S for forming terminal 20 is prepared. Terminal member S includes the plurality of terminals 20, carrier portion 30 (first carrier portion) connected to each of proximal end portions 21 of the plurality of terminals 20, and a carrier portion 35 (second carrier portion) connected to each of distal end portions 22 of the plurality of terminals 20. As carrier portions 30 and 35 connected to both ends of terminals 20, a member (carrier portion) for feeding a terminal reel which is sequentially fed when terminal 20 is manufactured may be used as it is. Thus, the following manufacturing process can be facilitated. However, carrier portions 30 and 35 may be provided separately. Further, housing 50 for the electrical connector configured to accommodate distal end portion 11a of electrical cable 10 (the plurality of electric wires 11), the plurality of terminals 20, and the like is prepared. Relay member 40 is attached to housing 50.

Subsequently, terminal member S is attached to the inside of housing 50 such that each of distal end portions 22 of the plurality of terminals 20 is located at a predetermined position with respect to housing 50 (bottom surface 51). Thus, each distal end portion 22 comes to protrude slightly from bottom surface 51 of housing 50 (see FIG. 5). At this time, carrier portion 30 is connected to proximal end portions 21 of the plurality of terminals 20, and carrier portion 35 is connected to each of distal end portions 22 of the plurality of terminals 20.

Subsequently, if necessary, the bending may be performed on the plurality of terminals 20 in a state in which the plurality of terminals 20 are kept connected to carrier portion 30 and carrier portion 35. By such bending, the shape of the plurality of terminals 20 along the longitudinal direction can be changed to a desired shape.

Subsequently, when the attachment of terminal member S to housing 50 is completed, carrier portion 35 is separated from the plurality of terminals 20. In this separation, all terminals 20 are cut and separated from carrier portion 35.

Subsequently, when the separation of carrier portion 35 is completed, a portion between signal terminal 20S used as the signal line among the plurality of terminals 20 and carrier portion 30 are cut. However, a portion between ground terminal 20G used as a ground line among the plurality of terminals 20 and carrier portion 30 are not cut. As a result, ground terminal 20G and carrier portion 30 remain connected to each other, and the ground structure is integrated.

Thereafter, electrical connector 1 is manufactured through the same process for the required number of electrical cables 10. In addition, when carrier portions 30 and 35 are carrier portions for feeding a product from a terminal reel, the electrical connector can be easily manufactured and manufacturing costs can be reduced. Also, manufacturing efficiency can further be increased by using the feed holes of carrier portions 30 and 35.

As described above, electrical connector 1 according to the embodiment has carrier portion 30 adjacent to proximal end portions 21 of the plurality of terminals 20, and ground terminal 20G is connected to carrier portion 30. Ground terminal 20G is integrated with carrier portion 30, and thus the ground in electrical connector 1 is stabilized. According to electrical connector 1, it is possible to reduce the influence of crosstalk and improve the communication performance of signals propagating through signal terminal 20S and the like.

In electrical connector 1, each of the plurality of terminals 20 has distal end portions 22 configured to be elastically deformable. Thus, the connection to electrode pad 65 on substrate 60 can be stabilized when electrical connector 1 is mounted on substrate 60.

Electrical connector 1 further includes relay member 40 that electrically connects each of proximal end portions 21 of the plurality of terminals 20 to each of distal end portions 11a of the plurality of electric wires 11. The position of each of proximal end portions 21 of the plurality of terminals 20 can be adjusted by changing the size and position of relay member 40. Thus, it is possible to adjust the position of each of distal end portions 22 of the plurality of terminals 20. As a result, when terminals 20 are arranged in a multipolar manner, each terminal 20 can be electrically connected to each electrode pad 65 corresponding to the terminal more stably.

The method of manufacturing an electrical connector according to the embodiment includes preparing terminal member S having the plurality of terminals 20 and carrier portion 30 connected to proximal end portions 21 of the plurality of terminals 20, preparing housing 50 for the electrical connector, the housing is configured to accommodate the plurality of terminals 20, attaching terminal member S to housing 50 such that each of distal end portions 22 of the plurality of terminals 20 is located at a predetermined position with respect to housing 50 (slightly protrudes from bottom surface 51), and cutting a portion between proximal end portion 21 of signal terminal 20S used as a signal line among the plurality of terminals 20 and carrier portion 30.

In the method of manufacturing the electrical connector, proximal end portion 21 of signal terminal 20S used as the signal line among the plurality of terminals 20 is cut from carrier portion 30. Since ground terminal 20G of the plurality of terminals 20 is integrated with carrier portion 30, the ground is stabilized. Thus, it is possible to easily obtain an electrical connector in which the influence of crosstalk is reduced and the communication performance of signals propagating through signal terminal 20S and the like is improved.

In the method of manufacturing electrical connector 1, terminal member S further includes carrier portion 35 connected to each of distal end portions 22 of the plurality of terminals 20. The method of manufacturing the electrical connector further includes separating carrier portion 35 from the plurality of terminals 20. Accordingly, terminal member S can perform various processes (for example, bending at a time) in a state in which the plurality of terminals 20 are arranged by carrier portion 30 and carrier portion 35. Thus, even when electrical connector 1 has a large number of terminals, the electrical connector can be easily manufactured.

The method of manufacturing the electrical connector may further include bending the plurality of terminals in a state in which the plurality of terminals 20 are kept connected to carrier portion 30 and carrier portion 35. In this case, the bending can be easily performed on a large number of terminals 20, and the uniformity of the bending can be secured. Thus, an electrical connector having stable communication performance can be easily obtained.

Although the embodiments of the present disclosure have been described in detail, the present disclosure is not limited to the above-described embodiments, and can be applied to various embodiments.

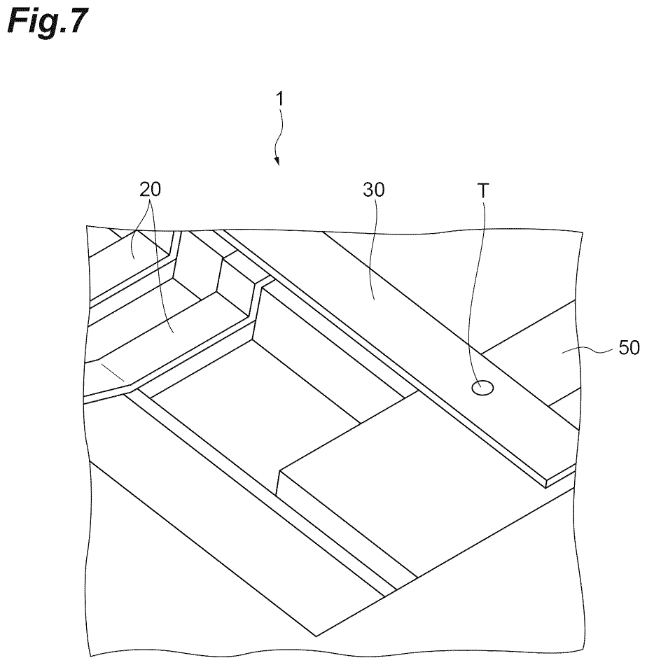

For example, as shown in FIG. 7, electrical connector 1 may be provided with a locking structure T configured to secure carrier portion 30 to housing 50. Locking structure T may be configured to provide with a hole or a recess penetrating carrier portion 30 and a convex portion provided at a corresponding portion of housing 50. The convex portion is fitted into the hole or the recess, so that carrier portion 30 is locked to housing 50. On the other hand, locking structure T may be configured such that a convex portion protruding toward housing 50 is provided on carrier portion 30, and a through hole or a recess fitted to the convex portion is provided at a corresponding position of housing 50. With such a configuration, even when an external force is applied to the plurality of terminals 20, the external force can be received by housing 50 via carrier portion 30 connected to the plurality of terminals 20. Thus, the external force can be dispersed, and the electrical connection of the plurality of terminals 20 to electrode pads 65 and the like can be stabilized.

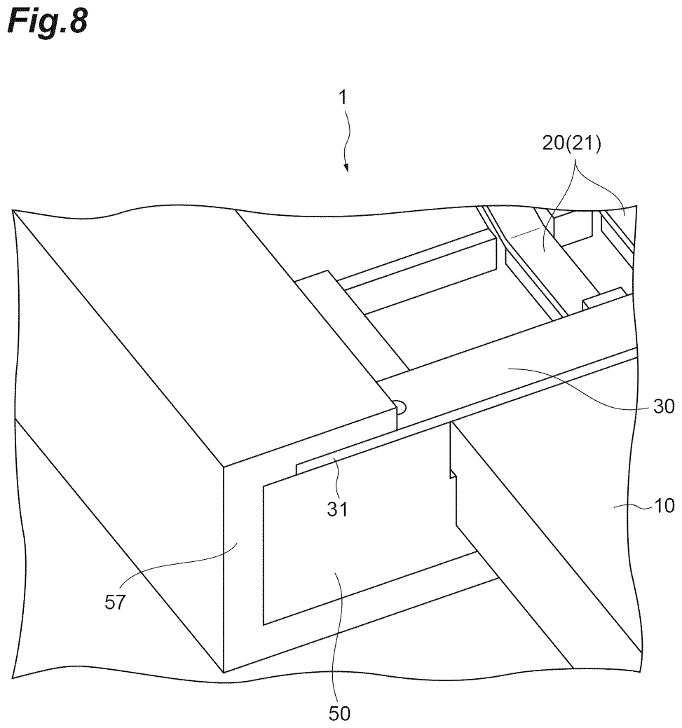

Further, as shown in FIG. 8, in electrical connector 1, in housing 50 having outer shell 57 made of metal, carrier portion 30 (an end portion 31) may be electrically connected to outer shell 57 and secured by outer shell 57. Carrier portion 30 is connected to metallic outer shell 57, so that the ground is further stabilized and the communication performance can be further improved. In addition, since carrier portion 30 is secured to outer shell 57, even when an external force is applied to the plurality of terminals 20, the external force is dispersed, and thus it is possible to stabilize the electrical connection of the plurality of terminals 20 to electrode pad 65 or the like.

What is claimed is:

1. An electrical connector comprising:
a plurality of conductors each extending along a first direction and arranged side by side in a second direction intersecting the first direction;
a plurality of terminals each extending along a third direction intersecting the first direction and the second direction and arranged side by side in the second direction, each of the plurality of terminals being configured to be electrically connected to a corresponding conductor among the plurality of conductors;
a carrier portion adjacent to proximal end portions of the plurality of terminals, the carrier portion extending in the second direction; and
a housing accommodating distal end portions of the plurality of conductors, the plurality of terminals, and the carrier portion, wherein
a ground terminal used as a ground line among the plurality of terminals is connected to the carrier portion, and
a signal terminal used as a signal line among the plurality of terminals is not connected to the carrier portion.

2. The electrical connector according to claim 1, wherein
each of the plurality of terminals has a distal end portion configured to be elastically deformable.

3. The electrical connector according to claim 1, further comprising:
a locking structure configured to secure the carrier portion to the housing.

4. The electrical connector according to claim 1, wherein
the housing includes an outer shell made of metal, and
the carrier portion is electrically connected to the outer shell and is secured by the outer shell.

5. The electrical connector according to claim 1, further comprising:
a relay member configured to electrically connect each of the proximal end portions of the plurality of terminals to a corresponding distal end portion among the distal end portions of the plurality of conductors.

6. An electrical connector comprising:
a first plurality of conductors each extending along a first direction and arranged side by side in a second direction intersecting the first direction;
a first plurality of terminals each extending along a third direction intersecting the first direction and the second direction and arranged side by side in the second direction, each of the first plurality of terminals being configured to be electrically connected to a corresponding conductor among the first plurality of conductors;
a first carrier portion adjacent to proximal end portions of the first plurality of terminals, the first carrier portion extending in the second direction; and
a housing accommodating distal end portions of the first plurality of conductors, the first plurality of terminals, and the first carrier portion, wherein
at least one first terminal among the first plurality of terminals is connected to the first carrier portion, and at least one second terminal among the first plurality of terminals is isolated from the first carrier portion.

7. The electrical connector according to claim 6, wherein
each of the first plurality of terminals protrudes from a bottom surface of the housing.

8. The electrical connector according to claim 7, wherein
each length of the first plurality of terminals protruding from the bottom surface is 10 μm to 1000 μm.

9. The electrical connector according to claim 6, wherein
the first plurality of terminals includes distal end portions each having a J-shape.

10. The electrical connector according to claim 6, wherein
the first carrier portion include a metal plate-like member.

11. The electrical connector according to claim 10, wherein
the first carrier portion includes at least one hole penetrating the metal plate-like member.

12. The electrical connector according to claim 6, wherein
the at least one first terminal includes two first terminals, and the second terminal is located between the two first terminals.

13. The electrical connector according to claim 6, wherein
the at least one first terminal includes two or more first terminals and the two or more first terminals are connected to the first carrier portion.

14. The electrical connector according to claim 6, further comprising,
a second plurality of conductors each extending along the first direction and arranged side by side in the second direction;
a second plurality of terminals each extending along the third direction and arranged side by side in the second direction, each of the second plurality of terminals being configured to be electrically connected to a corresponding conductor among the second plurality of conductors;
a second carrier portion adjacent to proximal end portions of the second plurality of terminals, the second carrier portion extending in the second direction, wherein
a first terminal among the second plurality of terminals is connected to the second carrier portion, and a second terminal among the second plurality of terminals is isolated from the second carrier portion.

15. The electrical connector according to claim 14, wherein
the length of each of the second plurality of terminals is shorter than the length of each of the first plurality of terminals.

16. The electrical connector according to claim 14, wherein
the second carrier portion is located closer to a bottom surface of the housing than the first carrier portion.

17. The electrical connector according to claim 14, wherein
the housing accommodates distal end portions of the second plurality of conductors, the second plurality of terminals, and the second carrier portion.

18. A method of manufacturing an electrical connector, comprising:
preparing a terminal member including a plurality of terminals and a first carrier portion connected to proximal end portions of the plurality of terminals;
preparing a housing for the electrical connector, the housing being configured to accommodate the plurality of terminals;
attaching the terminal member to the housing such that each of distal end portions of the plurality of terminals is located at a predetermined position with respect to the housing; and
cutting a portion between a proximal end portion of a signal terminal used as a signal line among the plurality of terminals and the first carrier portion.

19. The method of manufacturing an electrical connector according to claim 18, wherein
the terminal member further includes a second carrier portion connected to the distal end portions of the plurality of terminals, and
the method of manufacturing an electrical connector further comprises separating the second carrier portion from the plurality of terminals.

20. The method of manufacturing an electrical connector according to claim 19, further comprising:
bending the plurality of terminals in a state in which the plurality of terminals are kept connected to the first carrier portion and the second carrier portion.
